(19) United States
(12) Patent Application Publication
(10) Pub. No.: US 2013/0127611 A1
(43) Pub. Date: May 23, 2013

(54) BATTERY MARVEL 1.0

(71) Applicant: Battery Marvel, LLC., Atlanta, GA (US)

(72) Inventors: Gary BERNSTEIN, Atlanta, GA (US); David DECKER, Atlanta, GA (US)

(73) Assignee: BATTERY MARVEL, LLC., Atlanta, GA (US)

(21) Appl. No.: 13/680,927

(22) Filed: Nov. 19, 2012

Related U.S. Application Data
(60) Provisional application No. 61/561,896, filed on Nov. 20, 2011.

(51) Int. Cl. G08B 21/18

(52) U.S. Cl. CPC G08B 21/18
USPC 340/455

(57) ABSTRACT

A battery monitor comprising a memory and a processor is provided. The processor is in communication with the memory. The processor is configured to determine a state of a battery. The processor further determines whether to generate an alert based at least in part on the state. If the processor determines to generate the alert, the memory is configured to store a type of the alert and the state of the battery.

### TECHNICAL FIELD

The present invention relates to methods and systems for determining battery health, and specifically, to a method and system for determining an operational state of a battery.

### BACKGROUND

A modern vehicle includes a plurality electrical devices that interact with each other during vehicle operation. These electrical devices require a reliable source of power in order to function properly. While batteries can provide the necessary power, batteries require maintenance to perform as intended. For instance, the cable connections of the battery should be cleaned and tightened to prevent problems such as a dirty and/or loose connection. Additionally, the fluid electrolyte level in the battery should be checked regularly to prevent low levels of fluid, which may expose the battery plates to air.

Even though a battery may be properly maintained, a battery can still fail. For example, sulfation build-up causes the battery to become discharged. Sulfation affects the performance of the battery and may cause the battery to fail unexpectedly. The sulfur molecules in the electrolyte (battery acid) become discharged and begin to coat the lead plates of the battery. Sulfation contaminates the plates of the battery, reducing and eventually destroying the battery's ability to generate voltage and current. Sulfation may occur if a battery has not been charged for a while, if a battery is stored without an energy input, if the battery has low levels of electrolyte, if the battery is exposed to cold weather (which slows down the rate of reaction), heat (which increases the rate of reaction), etc. Since an operator of a vehicle may become stranded when the battery fails, monitoring the performance of a battery and storing the measured performance data may be desirable, as it may allow an operator to replace a battery before the battery condition becomes critical.

### SUMMARY

The present invention advantageously provides a method and system for determining the state of a battery. In accordance with one aspect, a battery monitor is provided. The battery monitor includes a memory and a processor in communication with each other. The processor is configured to determine a state of a battery. The processor is further configured to determine whether to generate an alert based at least in part on the state. If the processor determines to generate the alert, the memory is configured to store a type of the alert and the state of the battery.

According to another aspect, a method is provided. A state of a battery is determined using a battery monitor. A determination is made by the battery monitor as to whether to generate an alert based at least in part on the state. If a determination is made to generate the alert, a type of the alert and the state of the battery are stored in a log stored in the battery monitor.

According to another aspect, a system is provided. The system includes a vehicle and a battery monitor. The vehicle includes a battery and the vehicle's data network. The battery monitor is in communication with the vehicle via the data network. The battery monitor is connected to the battery. The battery monitor includes a memory, a transmitter, and a processor in communication with each other. The processor is configured to determine a state of a battery. The processor is further configured to determine whether to generate an alert based at least in part on the state. If the processor determines to generate the alert, the memory is configured to store a type of the alert and the state of the battery. The transmitter is configured to transmit the alert to the vehicle via the data network. The vehicle is configured to present the alert to an operator of the vehicle.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a block diagram of an exemplary system for determining the health of a battery in accordance with the principles of the present invention;

FIG. 2 is a block diagram of another exemplary system for determining the health of a battery, the system including a battery monitor in communication with a computer, constructed in accordance with the principles of the present invention;

FIG. 3 is a flow chart of an exemplary calibration process in accordance with the principles of the present invention;

FIG. 4 is a flow chart of an exemplary process for determining the state of a battery in accordance with the principles of the present invention;

FIG. 5 is a flow chart of an exemplary process for issuing an alert, in accordance with the principles of the present invention;

FIGS. 6A, 6B, 6C and 6D are block diagrams of an exemplary log, in accordance with the principles of the present invention;

FIG. 7 is a block diagram of an exemplary battery monitor in accordance with the principles of the present invention; and

FIG. 8 is a block diagram of a circuit for implementing a battery monitor constructed in accordance with the principles of the present invention.

### DETAILED DESCRIPTION OF THE INVENTION

Embodiments of the present invention provide a battery monitor, a method and a system for generating an alert. In accordance with an embodiment of the present invention, a battery monitor includes a memory and a processor in communication with each other. The processor is configured to determine the state of a battery. The processor is configured to determine whether to generate an alert based at least in part on the state. If the processor determines to generate the alert, the memory is configured to store a type of the alert and the state of the battery.

Before describing in detail exemplary embodiments that are in accordance with the present invention, it is noted that the embodiments reside primarily in combinations of apparatus components and processing steps related to implementing a battery monitor, a method and a system for monitoring the health of a battery. Accordingly, the battery monitor, method and system components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements.

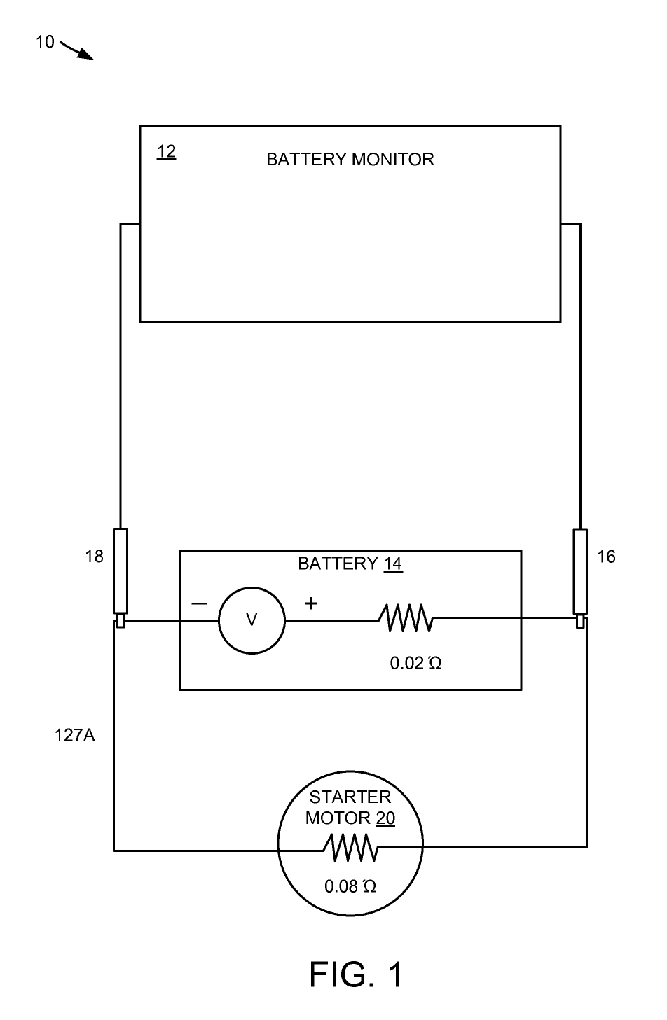

Referring now to the drawing figures in which reference designators refer to like elements, there is shown in FIG. 1 a diagram of an exemplary system constructed in accordance with the principles of the present invention and designated generally as “10”. System 10 includes battery monitor 12 connected to battery 14 via first connector 16 (power) and second connector 18 (ground). Battery 14 may be electrically connected to starter motor 20 (the engine's electric starter). Battery monitor 12 may be configured to monitor the health of battery 14. Battery monitor 12 may continuously monitor the operative status of battery 14 and the ambient temperature to determine the performance of battery 14. Battery monitor 12 may determine how the ambient temperature impacts the performance, capacity and service life of battery 14, and may identify an operating state of battery 14 based at least in part on the voltage, the temperature and a time. By way of example, battery monitor 12 may determine whether battery 14 is in a charging state, floating state, over voltage state, idle state, cranking state or under voltage state. Battery 14 may be a common twelve volts (12V) battery, such as the type of batteries found in cars, trucks, boats, motorcycles, recreational vehicles, all-terrain vehicles, personal watercraft vehicles, scooter, snowmobile, tractors, etc. Battery 14 may have a 0.02 ohms internal resistance, and starter motor 20 may have a 0.08 ohms resistance. A current running from battery 14 through starter motor 20 may be 127 amps.

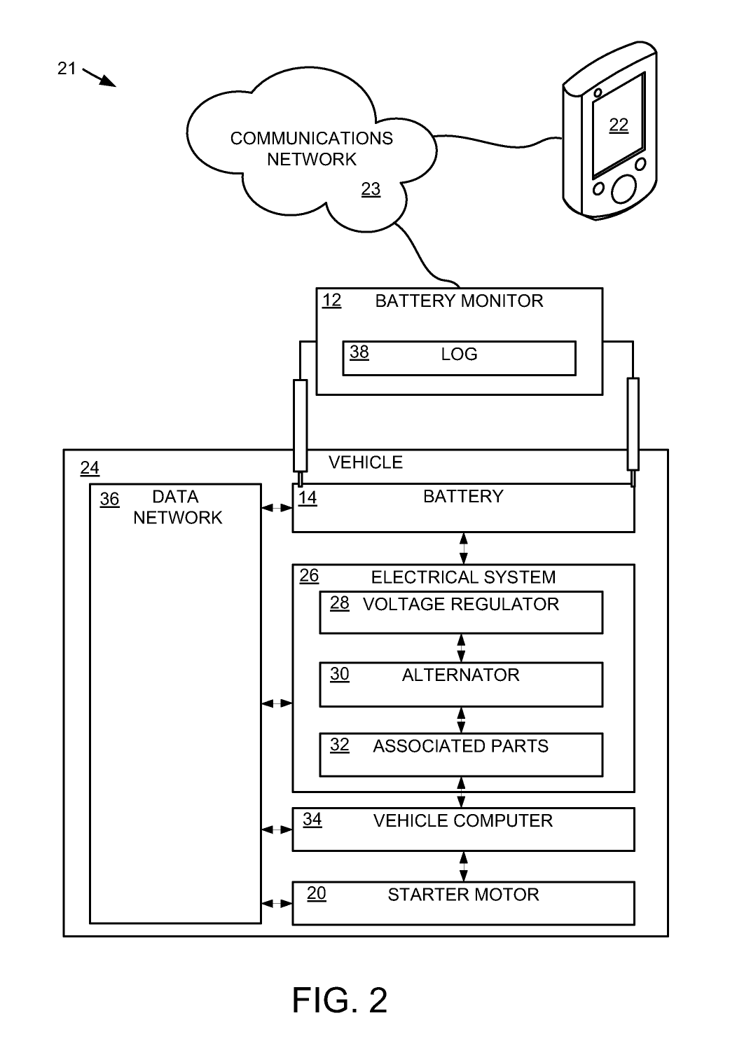

FIG. 2 is a block diagram of an exemplary system 21 including battery monitor 12 in communication with computer 22 via communication network 23. Computer 22 may be a mobile wireless device, a laptop computer, a desktop computer, and a tablet computer, among other types of computers. Communication network 23 may include a cellular communication network and the Public Switched Telephone Network (PSTN), or other wide area network (WAN), such as the Internet, as well as local area networks (LANs), such as an Ethernet LAN. Communication network 23 may be a wireless network, such as Wi-Fi, satellite, infrared, Bluetooth, Near Field Communications, or other communication network. Battery monitor 12 and computer 22 may be connected via communications network 23 to other computers, such as computers associated with an automobile manufacturer company, a battery retailer, an automobile dealer, an automobile repair shop, or any other third party (not shown).

Battery monitor 12 may be electrically connected to battery 14 in vehicle 24. Vehicle 24 may include starter motor 20, battery 14 and electrical system 26, which may include voltage regulator 28, alternator 30 and other associated parts 32, such as the starting motor and the various electrical and physical sensors for inputs to data network 36. Battery monitor 12 may also be configured to monitor the health of electrical system 26 of vehicle 24. For instance, battery monitor 12 may continuously monitor the operative status of battery 14 and the ambient temperature to determine the performance of electrical system 26.

Vehicle 24 further includes vehicle computer 34 and data network 36, which may be a communication infrastructure or communication bus. Electrical system 26 may communicate with battery monitor 12, motor 20, battery 14 and vehicle computer 34 directly or via data network 36. Electrical system 26 may send data to battery monitor 12 via data network 36. Data sent via data network 36 may include data related to electrical system 26, such as data associated with voltage regulator 28, alternator 30 and/or associated parts 32.

In another exemplary embodiment, vehicle computer 34 may communicate with battery monitor 12 and vehicle components, such as motor 20 and electrical system 26, e.g., voltage regulator 28, alternator 30 and associated parts 32, directly or via data network 36 using a networking protocol such as a controller area network (“CAN”) protocol, a Local Interconnect Network (“LIN”) protocol, among other protocols. Data network 36 may be an internal communication network interconnecting vehicle computer 34 with motor 20, and electrical system 26. Other vehicle components may include an Engine Control Unit (“ECU”), a Transmission Control Unit (“TCU”), and an Anti-lock Braking System (“ABS”) among others. By way of example, starter motor 20 of vehicle 24 may communicate its speed via data network 36 to the TCU of vehicle 24.

In an exemplary embodiment, battery monitor 12 may communicate with vehicle computer 34 via data network 36. Vehicle computer 34 may send data to battery monitor 12, such as data associated with the operation of vehicle 24 or any component of vehicle 24, via data network 36. For instance, battery monitor 12 may receive from vehicle computer 34 the voltage and temperature of battery 14 and electrical system 26, in addition to the time and calendar date. Battery monitor 12 may also communicate with electrical system 26 and motor 20 via data network 36.

Battery monitor 12 may be configured to infer a diagnosis regarding the health of voltage regulator 28, alternator 30 and associated parts 32 of vehicle 24. The voltage measured by battery monitor 12 at battery 14 or the voltage of battery 14 received by battery monitor 12 from electrical system 26 via data network 36, may be reflective of the health of electrical/charging system 26. For example, if battery 14 is overcharging, then battery monitor 12 may infer that voltage regulator 28 is not working. As another example, if battery monitor 12 measures that there is no crank or that there is a slow crank, this may indicate that the electrical system is not working. As another example, if battery monitor 12 measures that the vehicle is not running (from the data received from the data network 36), but the battery voltage is decreasing, this may indicate that battery 14 is slowly discharging to a point that it may need charging or replacement.

Voltage regulator 28 maintains a proper level of current during charging for battery 14 in order to prevent battery 14 from running down or overcharging. Voltage regulator 28 changes the amount of direct current sent to battery 14 by regulating the amount of negative ground sent to a rotor in alternator 30 or by regulating the amount of positive ground. Alternator 30 of vehicle 24 uses magnetism to generate electricity for vehicle 24 In another exemplary embodiment, battery monitor 12 receives data from data network 36. Data may include the battery voltage of battery 14, the revolutions per minute of starter motor 20, an intake manifold temperature, exhaust manifold temperature, a cabin temperature inside vehicle 24, a calendar date, and a time. Battery monitor 12 may receive the data four times per second from data network 36 and/or vehicle computer 34. Battery monitor 12 may use the data received to determine the operating condition (good or bad) and the operating state of battery 14. The speed of the engine may be obtained from the transmission control unit sensor, the intake manifold temperature may be obtained from the engine fuel/air management system sensor, the cabin temperature may be obtained from the climate control system sensor(s), and the calendar date and time may be obtained from sensors included in the cabin clock. Battery monitor 12 may store the data received from data network 36 in log 38.

In another exemplary embodiment, the intake manifold temperature received by battery monitor 12 from data network 36 may be the temperature of the air being supplied to engine and/or the temperature of the part of engine which supplies the fuel and air mixture to the cylinders of vehicle 24. The intake manifold temperature is used by the engine's fuel/air management system to optimize engine combustion performance and minimize harmful byproducts of internal combustion. The exhaust manifold temperature may be the temperature of the air exhausted by vehicle 24 and/or the part of the engine which collects the exhaust gases. Battery monitor 12 may store the intake manifold temperature and the exhaust manifold temperature in log 38.

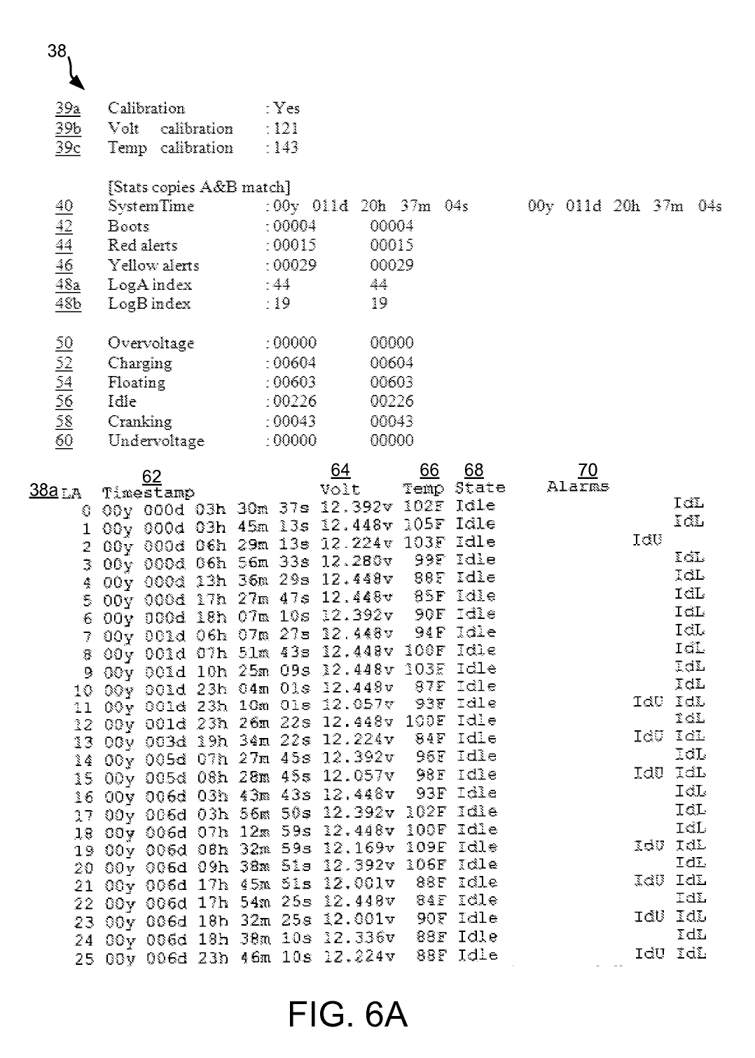

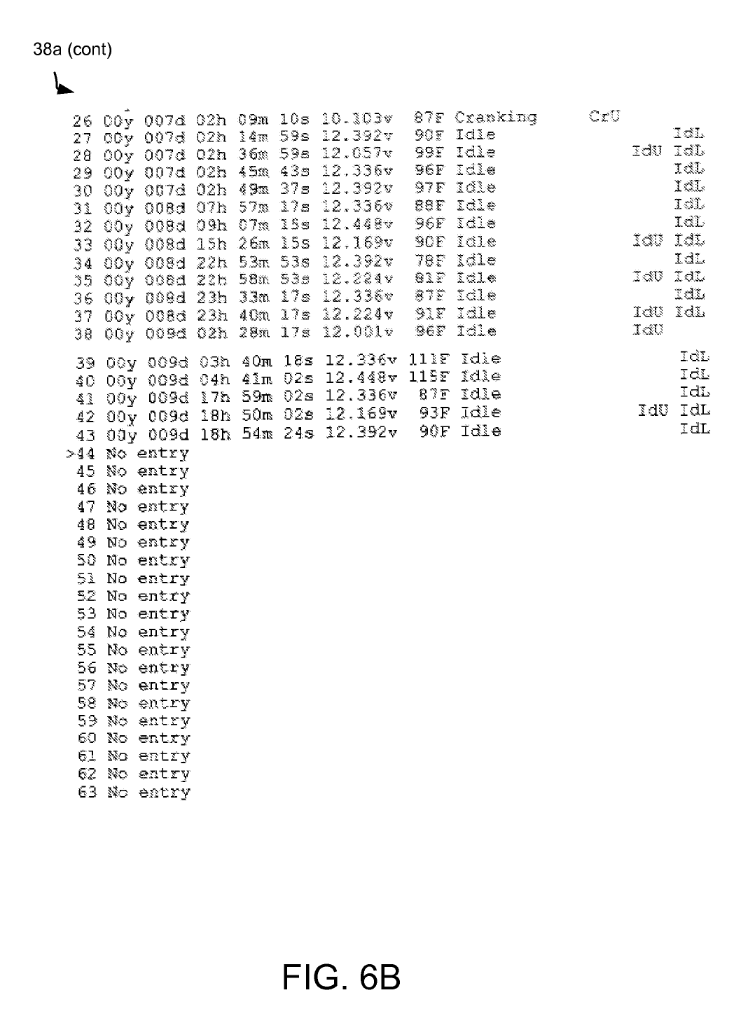

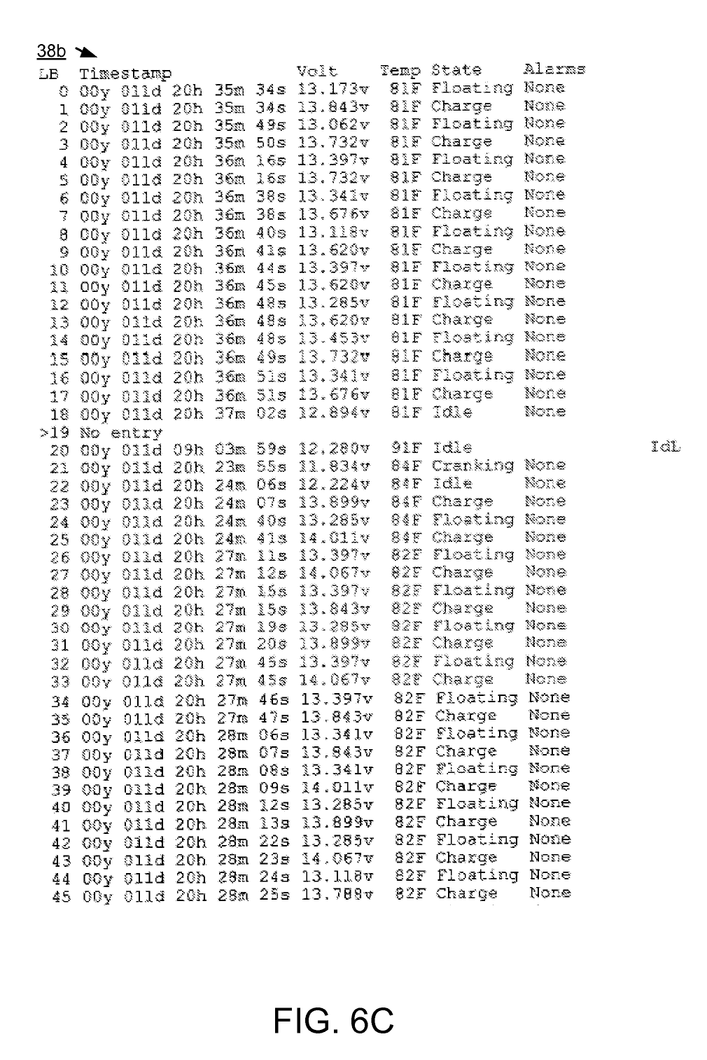

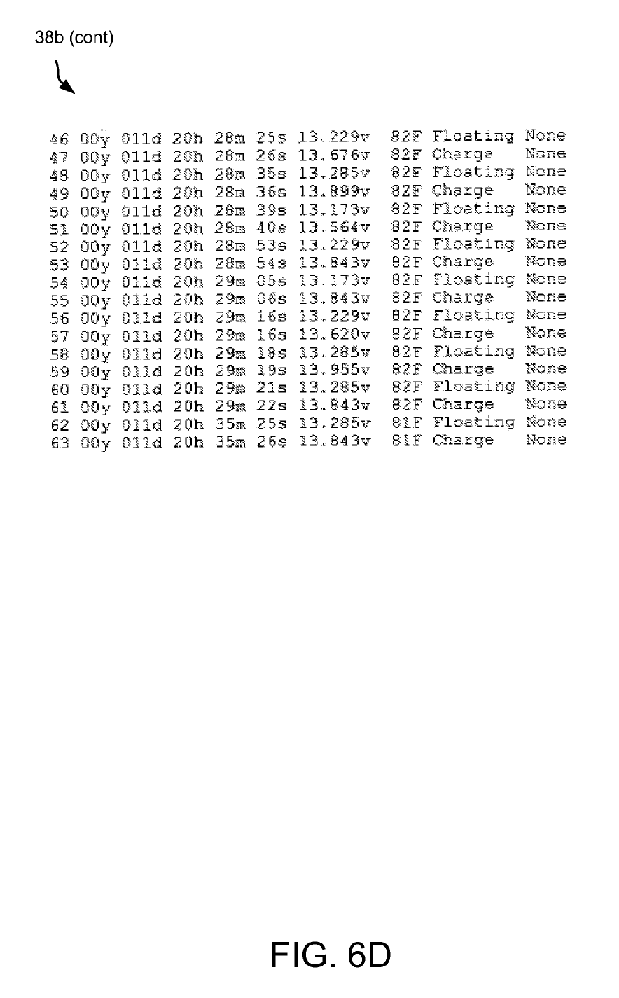

In another exemplary embodiment, battery monitor 12 uses the calendar date and time to determine a length of time battery 14 is in a particular state. Battery monitor 12 may determine that battery 14 is in a charging state, overcharging state, idle state, floating state, under voltage state or cranking state by using the inputs of voltage received from data network 36, i.e., the voltage of battery 14 or the voltage of electrical system 16, or both. Battery monitor 12 determines the length of time battery 14 remains in a particular state, and stores the state of battery 14, the length of time battery 14 remained in that state, the calendar date and the time in log 38. For example, log 38 (shown in FIGS. 6A-6D) shows in lines zero (“0”) and one (“1”) that battery 14 was in an idle state for fifteen minutes. Line zero shows that at 03 h 30 m 37 s the state of battery 14 was “Idle,” and that fifteen minutes later at 03 h 45 m 13 s, the state of battery 14 was still “Idle.” As such, battery 14 remained in the “Idle” state for fifteen minutes.

In another exemplary embodiment, battery monitor 12 receives from data network 36 the voltage of electrical system 26 of vehicle 24 and the temperature of intake manifold of the engine or starter motor 20 The voltage of electrical system 26 and the temperature of intake manifold of the engine or starter motor 20 are used to determine the voltage of battery 14 and the temperature of battery 14. If in said vehicle 24, the battery 14 is stored in the same compartment as the engine, then intake manifold temperature is the same as the temperature of battery 14. If in said vehicle 24, the battery 14 is stored in the cabin, then cabin temperature is the same as the battery temperature. Battery monitor 12 adjusts the voltage of battery 14 according to temperature, e.g., normalizes the voltage.

Battery monitor 12 compares the temperature corrected voltage of electrical system 26 to a value in a table stored in battery monitor 12. Temperature corrected voltages of a 12V battery are available in the public domain. The data received by battery monitor 12 is data which is used by vehicle 24, i.e., battery monitor 12 works with data already available and in use by vehicle computer 34 of vehicle 24. For example, the safety control system, the climate control system and the engine management system of vehicle 24 already use the same data to perform their own functions.

In another exemplary embodiment, battery monitor 12 may transmit an alert, which may include a warning message, using data network 36. Vehicle 24 may receive the alert transmitted by battery monitor 12 and may warn the operator of vehicle 24 of the alert visually or audibly. Battery monitor 12 may send the alert to a component of vehicle 24, such as vehicle computer 34, via data network 36. The alert may contain a message or instructions for the component of vehicle 24, such as vehicle computer 34, to direct a sound system, warning light system and/or alert system in vehicle 24 to communicate the alert to the operator of vehicle 24. For instance, the alert may instruct vehicle computer 34 to display the alert on a display of vehicle 24. The display in vehicle 24 may display the warning message included in the alert.

In another exemplary embodiment, the alert may include instructions instructing vehicle computer 34 to present the alert to an operator of vehicle 24. For instance, the instructions may instruct vehicle computer 34 to display a visual alert, such as to flash a light in vehicle 24. Battery monitor 12 may cause a light on a dashboard of vehicle 24 to light up or flash. The light may provide notice to an operator of vehicle 24 of a potential problematic condition with battery 14 or with a component of vehicle 24. Battery monitor 12 may provide critical data to data network 36 regarding battery 14. Battery monitor 12 may request vehicle computer 34 to light a green, yellow or red LED based at least in part on the type of alert sent to vehicle computer 34.

In another exemplary embodiment, the alert may instruct a sound system in vehicle 24 to play an alert sound, which may be an alert tone, such as a beep, or an electronic voice alert. The voice alert or the alert displayed in the display may describe the reason why the alert was issued, and may advise the operator of vehicle 24 as to the source of the problem and a possible way to solve the problem. For example, the alert displayed on the display or played audibly may include the following message: “Battery is over charging. Please replace the voltage regulator.” As such, data network 36 of vehicle 24 can be used to assist battery monitor 12 in issuing an alert in that vehicle 24 itself, rather than battery monitor 12, may actually be used to alert about a problem with electrical system 26 and/or battery 14. The alert may be in the form of a visual alert, such as a light, an audible alert, such as a voice or alert tone, or a network message.

In another exemplary embodiment, battery monitor 12 may send the alert as a network message wirelessly to computer 22 via communication network 23. The alert may indicate a description of the problem found by battery monitor 12, such as “battery is under charging.” The alert may further indicate an action that the operator of vehicle 24 should take, such as “please replace the battery,” or “please inspect the alternator.”

In another exemplary embodiment, computer 22 may be a computer associated with an operator of vehicle 24, e.g., a user computer, a manufacturer of vehicle 24, a dealer of vehicle 24, a road assistance computer, or any computer 22 associated with vehicle 24. Battery monitor 12 may send an alert to computer 22, which may be a subscription based computer. The alert sent by battery monitor 12 to the subscription based computer 22 may include the location of vehicle 24. The alert may include data on the condition of vehicle 24 or any part of vehicle 24, such as battery 14, starter motor 20, electrical system 26, voltage regulator 28, alternator 30 and other associated parts 32. For example, battery monitor 12 may upload the abnormal condition alert to an OnStar® computer for their information. Other subscription based services computers may include computers associated with Orion Vehicle Intelligence System™ and In-Drive™ from State Farm Insurance™.

In another exemplary embodiment, battery monitor 12 may use the same audio and visual outputs to upload data in log 38 to any other device configured to accept the data, such as computer 22, which may be a mobile phone having a mobile phone application designed to accept, analyze, display and organize the data. Battery monitor 12 may communicate with computer 22 via a wireless or wired interface or by directly interpreting encoded output from the battery monitor's LED or audio elements.

In another exemplary embodiment, the alert may be an email, a text message, a voice message, or may be displayed at a website. For instance, the alert may be sent as a text message to computer 22. The alert may include a Uniform Resource Locator (“URL”) of a website. A browser installed in computer 22 may navigate to the website corresponding to the url. The website may display the alert, which may be in the form of a message such as “battery needs to be replaced.” By means of example, when the voltage of battery 14 is less than 8V, battery monitor 12 may issue an alert indicating that battery 14 is not working properly (battery 14 may be discharged or may be failing). The alert may include a message stating that “the battery is failing. Please replace the battery.” As another example, when the voltage is over 15V then battery monitor 12 determines that voltage regulator 28 is malfunctioning. Battery monitor 12 may send an alert message to computer 22 indicating that voltage regulator 28 of vehicle 24 is malfunctioning. The alert message may state the following: “voltage regulator malfunction.” As another example, when the voltage is below the expected charging voltage of alternator 30, battery monitor 12 may send an alert message to computer 22. The alert message may state the following: “battery is undercharging, please evaluate the alternator.”

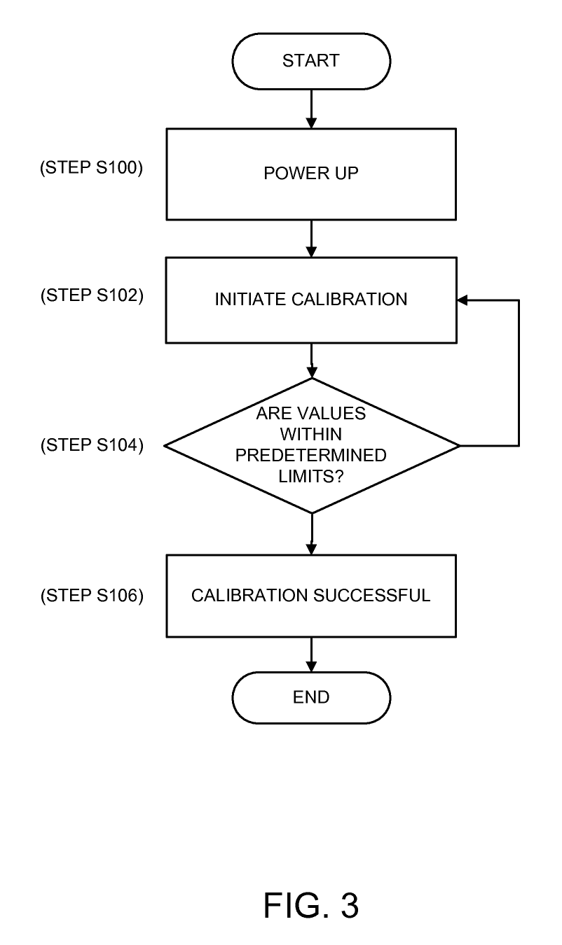

FIG. 3 is a flowchart of an exemplary process for calibrating battery monitor 12. During the first power up/boot up (Step S100) of battery monitor 12, battery monitor 12 may run a calibration routine (Step S102). Battery monitor 12 may perform a self-check to assure that the calibration is within predetermined limits. Battery monitor 12 measures voltage and temperature during calibration. The calibration results are compared with predetermined limits for the given hardware components from which it is constructed. For example, when battery monitor 12 may be configured to compute a calibration value based at least on the temperature and voltage. If the calibration value falls in the range of 1-150, then battery monitor 12 may determine that the calibration was successful, and when the value falls in the range of 151 or greater, then battery monitor 12 may determine that the calibration was not successful.

If battery monitor 12 determines that the calibration measurements exceed or fall below the predetermined limits, battery monitor 12 repeats the calibration routine (Step S104). If battery monitor 12 determines that the calibration values fall within the range of 1-150, then battery monitor 12 determines that the calibration was successful (Step S106). Battery monitor 12 proceeds to store and log the results of the calibration in log 38, such as the voltage at calibration and the temperature at calibration. If the values are not within predetermined limits, battery monitor 12 initiates the calibration again (Step S102). Each time battery monitor 12 is connected to a power source (every time battery monitor 12 boots), the additional boot is also recorded in log 38.

In another exemplary embodiment, battery monitor 12 may be configured to auto-calibrate on initial power up at the factory. The auto-calibration allows battery monitor 12 to calibrate its operations based on the expected variations in hardware component tolerances. Resistors, capacitors, diodes, and the battery monitor's 12 own voltage regulator all have a range of tolerances that can vary from individual part to part. If battery monitor 12 determines that the calibration is faulty, battery monitor 12 may be configured to automatically rerun the calibration sequence.

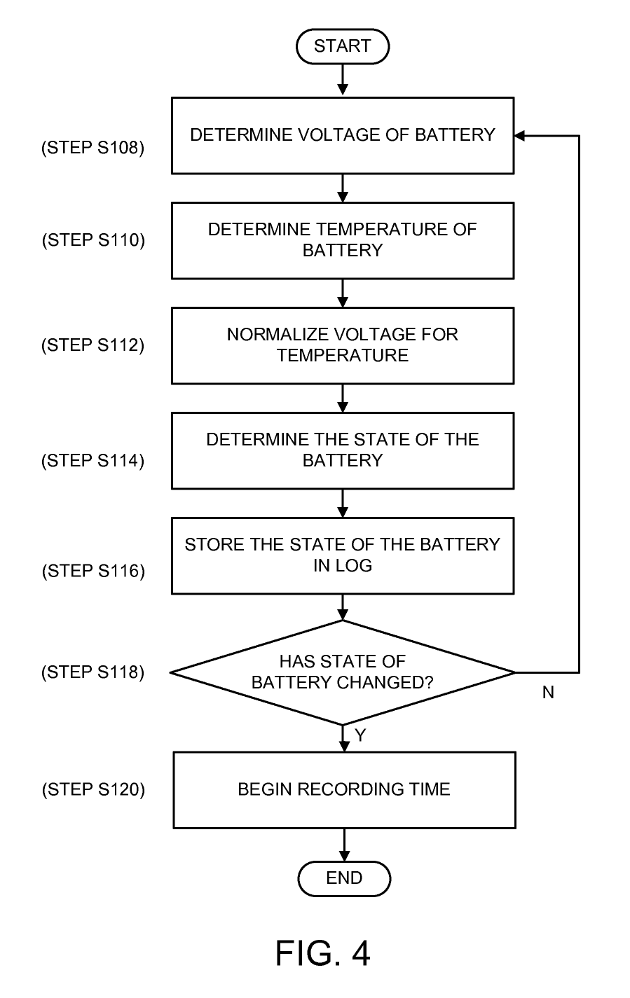

FIG. 4 is a flowchart of an exemplary process for determining the temperature and voltage of battery 14 using battery monitor 12. Battery monitor 12 determines the voltage and the temperature of battery 14 by either receiving the current temperature and current voltage of battery 14 from data network 36 or by measuring the current temperature and the current voltage of battery 14 (Steps S108 and S110). Battery monitor 12 normalizes the voltage for the temperature (Step S112). By way of example, the voltage may be corrected to 60 degrees Fahrenheit. Voltage data is normalized according to the temperature to account for the different expected performance of battery 14 at different temperatures. For example, the voltage drop will change according to temperature, e.g., a colder battery is less powerful than a warmer battery. The following exemplary table shows how the voltages may be normalized:

TABLE 1
Normalized Voltages measured at 60 degrees Fahrenheit

| Measured | | Normalized |
|---|---|---|
| Voltage | Measured Temperature | Voltage |
| 15 | 80 degrees Fahrenheit | 14.8 |
| 14 | 80 degrees Fahrenheit | 13.8 |
| 13 | 80 degrees Fahrenheit | 12.8 |
| 12 | 80 degrees Fahrenheit | 11.8 |
| 11 | 80 degrees Fahrenheit | 10.8 |
| 10 | 80 degrees Fahrenheit | 9.8 |
| 9 | 80 degrees Fahrenheit | 8.8 |
| 8 | 80 degrees Fahrenheit | 7.8 |

Table 2 is another exemplary table showing normalized voltages when the temperature is 32 degrees Fahrenheit (0 degrees Celsius). Table 1 and Table 2 or a representation of Table 1 and Table 2 (such as code representing the tables) may be stored in battery monitor 12.

TABLE 2
Normalized Voltages measured at 32 degrees Fahrenheit

| Measured Voltage | Measured Temperature | Normalized Voltage |
|---|---|---|
| 15 | 32 degrees Fahrenheit | 15.5 |
| 14 | 32 degrees Fahrenheit | 14.5 |
| 13 | 32 degrees Fahrenheit | 13.5 |
| 12 | 32 degrees Fahrenheit | 12.5 |
| 11 | 32 degrees Fahrenheit | 11.5 |
| 10 | 32 degrees Fahrenheit | 10.5 |
| 9 | 32 degrees Fahrenheit | 9.5 |
| 8 | 32 degrees Fahrenheit | 8.5 |

The normalized voltage may be compared to a value stored in Table 3 that is publicly available and stored in battery monitor 12.

TABLE 3

| Temperature Fahrenheit | Voltage of 12 Volt battery |
|---|---|
| 120 | 12.5 |
| 100 | 12.4 |
| 80 | 12.2 |
| 70 | 12 |
| 60 | 11.95 |
| 40 | 11.8 |
| 20 | 11.5 |

Table 4 (below) may be used to determine a state of battery 14:

| | Preset | |
|---|---|---|
| Temperature | Threshold | State of Battery |
| 60 F. | 9 V | Failing battery |
| 60 F. | 11 V | Idle under |
| 60 F. | 12 V | Idle |
| 60 F. | 14 V | Charging |
| 60 F. | 15.5 V | Overcharging |

The normalized voltage is compared with preset thresholds (which are publicly available), i.e., the preset thresholds stored in Table 3. Table 3 or a representation of Table 3, such as code representing Table 3, may be stored in battery monitor 12. Battery monitor 12 determines the state of battery 14 and whether the voltage falls outside of predetermined limits (Step S114). Battery monitor 12 may determine the state of battery 14 using Table 3.

Battery monitor may store the determined state of battery 14 in log 38 (Step S116). Additionally, battery monitor 12 determines whether the state of battery 14 has changed by comparing the previous stored state in log 38 with the current determined state of battery 14 (Step S118). If the state of battery 14 has changed, battery monitor 12 begins recording the time, e.g., the time that the state of battery 14 changed and how long battery 14 remains in that particular state (Step S120). For instance, line twenty six in log A 38a (shown in FIG. 6B) shows that battery monitor 12 determined that battery 14 has been in a cranking state with lower than expected voltage. As another example, line zero of log A 38a shows that battery 14 was in an idle state at 03 h 30 m and 37 s and remained in the idle approximately three more hours until a voltage drop was logged (line 3).

Tables 1, 2, and 3 stored in battery monitor 12 may be programmable so that customized tables may be created for specific vehicles that may have unique requirements. For example a customized Table 1 may include increasing or decreasing the normalized voltages for each temperature based on the actual physical properties of the battery 14 used. A customized Table 3 may include increasing or decreasing voltage thresholds based on the actual demands of the individual vehicle and electrical system components.

In another exemplary embodiment, battery monitor 12 may monitor the voltage and temperature of battery 14 four times a second. Battery monitor 12 may notify when there is a slow discharge of battery 14 from, for example, lack of use or a small electrical drain (such as when the headlights are left on). A slow discharge of the battery would gradually lower the voltage over time as the battery discharges. The voltage drop would be logged and battery monitor 12 may trigger an alert.

Further, battery monitor 12 may detect overcharging and undercharging of battery 14 during the operation of vehicle 24 and may detect whether battery 14 is failing during start of vehicle 24. Battery monitor 12 alarms when it detects that battery 14 is dead, i.e., the voltage of battery 14 is below 9 volts (Table 3).

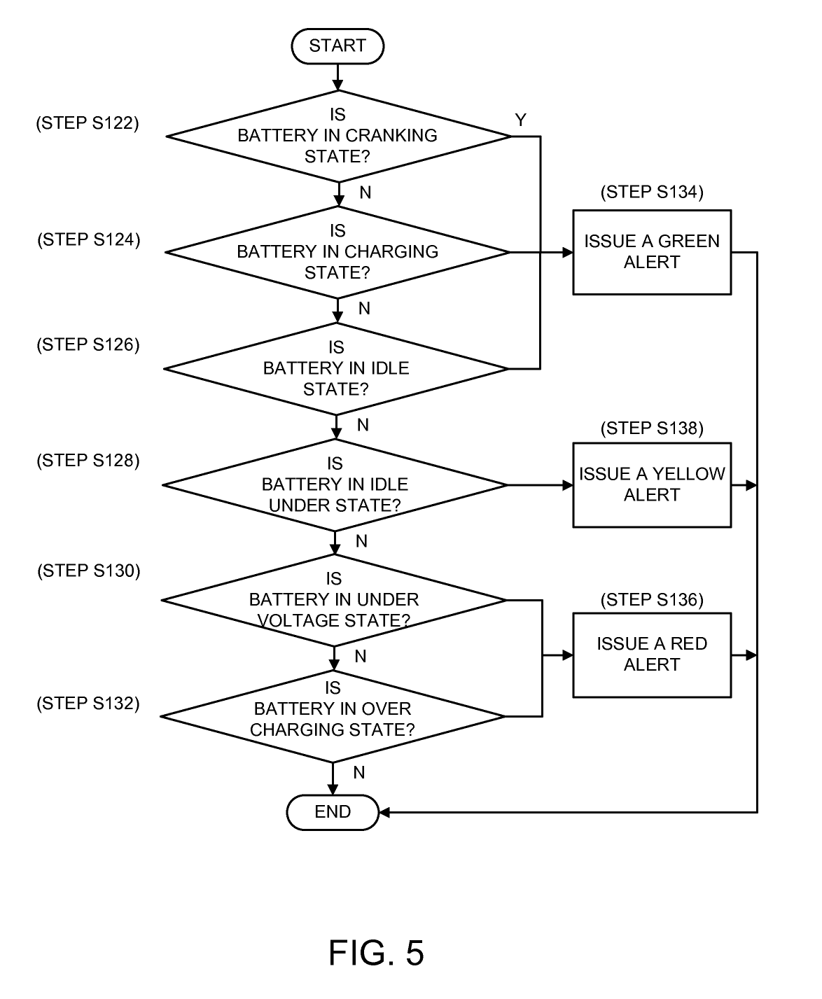

FIG. 5 is a flowchart of an exemplary process of the actions performed by battery monitor 12 based at least in part on the state of battery 14. In an exemplary embodiment, battery monitor 12 may detect whether battery 14 is in a charging state, floating state (above idle but below undercharging), overcharging/over voltage state, idle state (that is neither charging nor discharging), under voltage state (which may become a cranking state or an idle under state, or a cranking under state by analyzing the inputs of voltage, temperature, and system time.

Battery monitor 12 may generate an alert. The alert may be a type of alert of a plurality of alert types. Battery monitor 12 may determine to generate an alert based at least in part on the state of battery 14. The state in which battery 14 is in may depend on the temperature and voltage of battery 14. The different alerts that battery monitor 12 may issue may be of different types, such as a charging state alert type (“Chr”), an overcharging/overvoltage state alert type (“OvC”), an idle state alert type (“IdL”), an undercharging/floating state alert type (“UnC”), an under voltage state alert type (“UnV”), a cranking state alert type (“Cr”), an idle under state alert type (“IdU”), and a cranking under state alert type (“CrU”).

A different type of alert is generated, depending on the condition/status of battery 14. Battery monitor 12 may store in log 38 the time when the state of battery 14 is determined and the type of alarm that was generated. Battery monitor 12 may generate different alert types by powering one of a flashing green light, a flashing yellow light, a flashing red light, a solid green light, a solid yellow light and a solid red light. The length of the alert and repeat interval of the alert may vary depending on which abnormal event occurred. For example, if battery 14 is in an overcharging state, the alerts may repeat every minute, while if battery 14 is slowly discharging, then the alert may repeat every two hours.

In another exemplary embodiment, monitor 12 may determine that battery 14 is in a charging state (Step S124). Battery monitor 12 may display an alert to indicate that battery 14 is in a charging state. Battery monitor 12 may generate an alert of a charging state alert type. For example, battery monitor 12 may illuminate a green LED solid green (Step S134) or may illuminate a visual indicator in vehicle 24, such as a light in vehicle 24. Battery monitor may send the alert to computer 22, which may be a mobile device, via text message, email, etc. Battery monitor 12 logs the system time, the voltage, the temperature and the charging state in log 38. Battery monitor 12 may store the length of time that battery 14 remained in the charging state in log 38.

In another exemplary embodiment, battery monitor 12 determines that battery 14 is in an overcharging/overvoltage state (Step S132). Battery monitor 12 logs the overcharging state of the battery in log 38. Once battery monitor 12 determines that battery 14 is in an overcharging state, battery monitor 12 determines how long battery 14 remains in the overcharging state. If battery monitor 12 determines that battery 14 is in the overcharging state for a predetermined time, then battery monitor 12 may generate an alert of an overcharging/overvoltage state alert type. Battery monitor 12 may alert the operator of vehicle 24 by, for example, playing an audible alert or by sending an alert to vehicle 24 so that the alert may be played by speakers in vehicle 24. Alternatively, battery monitor 12 may illuminate an LED solid red (Step S136) or may transmit the alert to vehicle 24, so that the alert may be displayed at a visual indicator of vehicle 24, such as a display in vehicle 24 or a light of vehicle 24. Battery monitor 12 may store the length of time that battery 14 remained in the overcharging state in log 38, along with the voltage, the temperature, an overcharging alert indicator that indicates that the overcharging alert was issued and the overcharging state. Further, battery monitor 12 determines the amount of time that battery 14 remains in the overcharging state and logs the time in log 38. If battery monitor 12 determines that battery 14 remains in the overcharging state, then battery monitor 12 repeats the alert at predetermined intervals.

In another exemplary embodiment, battery monitor 12 may determine that battery 14 is in an idle state (Step S126). Battery monitor 12 may generate an alert of an idle state alert type. Battery monitor may display an alert, such as by flashing a green LED (Step S134) on and off or by flashing a visual indicator in vehicle 24. Battery monitor 12 may store the length of time that battery 14 remained in the idle state in log 38.

In another exemplary embodiment, battery monitor 12 may determine that battery 14 is in an undercharging/floating state. Battery monitor 12 may generate an alert of an undercharging/floating state alert type. Battery monitor may display an alert, such as by flashing a red LED on and off or by flashing a visual indicator in vehicle 24. Battery monitor 12 may store the length of time that battery 14 remained in the undercharging/floating state in log 38.

In another exemplary embodiment, battery monitor 12 may determine that battery 14 is in an under voltage state (Step S130). Battery monitor 12 may generate an alert of an under voltage state alert type. If battery 14 remains in the under voltage state for less than a predetermined amount of time, battery monitor 12 may determine that battery 14 is in a cranking state (Step S122) between idle under and cranking under. Battery monitor 12 may generate an alert of a cranking state alert type. Battery monitor 12 may display an alert to indicate that battery 14 is in a cranking state (Step S134). For example, battery monitor 12 may illuminate a green LED solid green on and off or may illuminate a visual indicator in vehicle 24, such as a light in vehicle 24. Battery monitor may send the alert to computer 22, which may be a mobile device, via text message, email, etc. Battery monitor 12 logs the system time, the voltage, the temperature and the cranking state in log 38.

Else, if battery 14 remains in the under voltage state longer than a predetermined length of time, battery monitor 12 may determine that battery 14 is in an idle under state. Battery monitor 12 may generate an alert of an idle under state alert type. Battery monitor 12 may alert an operator of vehicle 24 by flashing a yellow LED on and off (Step S138) or by using a visual indicator of vehicle 24 when battery 14 is in an idle under state. For instance, battery monitor 12 may display a message on a display of vehicle 24, may flash a light of vehicle 24, may sound an audible alert, may use the speakers of vehicle 24 to sound an audible alert, etc. Battery monitor 12 may also communicate to computer 22 that battery 14 is in an idle under state. Battery monitor 12 determines whether battery 14 remains or not in the idle under state. If so, battery monitor 12 repeats the alerting. Battery monitor 12 stores the system time, voltage, temperature and the idle under state in log 38. Additionally, battery monitor 12 stores an idle under state indicator indicating that battery 14 experienced an idle under state, and the length of time that battery 14 was in the idle under state.

In another exemplary embodiment, battery monitor 12 may determine that battery 14 is in a cranking under state. Battery monitor 12 may generate an alert of a cranking under state alert type. If battery monitor 12 determines that battery 14 has been in the cranking under state for a predetermined time, then battery monitor 12 may alert an operator of vehicle 24. Battery monitor 12 may alert an operator by flashing a red LED on and off or by flashing a visual indicator in vehicle 24. For instance, battery monitor 12 may communicate with vehicle 24 and may be configured to use visual or sound indicators of vehicle 24. Battery monitor 12 may display a message on a display of vehicle 24 or may flash a light of vehicle 24. Battery monitor 12 may issue an audible sound alert, e.g., may play a sound alert. For instance, battery monitor 12 may play a sound alert on the speakers of vehicle 24, which may be a voice alert or a beep sound alert. Battery monitor 12 logs the system time, the voltage the temperature and a cranking under state indicator indicating that battery 14 is in the cranking under state in log 38. Battery monitor 12 may store the type of alert issued in log 38, such as a flashing red LED alert, etc. Battery monitor 12 determines whether battery 14 is still in the cranking under state. If so, battery monitor 12 repeats the alert at predetermined intervals if the state has not changed. Battery monitor 12 may store the length of time that battery 14 remained in the under voltage state in log 38.

Battery monitor 12 may log the system time, the voltage, the temperature and the state of battery 14 in log B 38b, i.e., the normal events log, when there are any changes in the state of battery 14. Log B 38b may store data every time there is a change in the state of battery 14, including normal states and abnormal states regardless as to whether or not an alert was issued. The normal events log B 38b may also record the time, temperature and voltage after a predetermined period of time in the event of inactivity of battery 14, i.e., when vehicle 24 is not running. For example, the predetermined interval may be eighteen hours. On the other hand, when there is a change in the state of battery 14 that indicates that battery 14 is in a condition that needs alerting, such as a condition where the state of the battery is not normal, battery monitor 12 may log the system time, the voltage, the temperature, the state of battery 14, and the type of alarm issued in log A 38a, i.e., the abnormal events log.

In another exemplary embodiment, battery monitor 12 may sample voltage regularly, many times per second, and may assign a state based on voltage and temperature readings. When a cranking state is assigned, a certain period of time is allowed to elapse and then the lowest voltage is logged into log 38. This logged voltage is normalized for temperature and the normalized voltage is stored in log 38. The normalized voltage is compared to a value in a table in order to calculate the normalized SOH of battery 14.

In another exemplary embodiment, battery monitor 12 includes programming logic to minimize false positives and false negatives. If battery 14 is idle, regular monitoring of the voltage by battery monitor 12 may show a slow drain from an unused battery or that an electrical device is left on. Battery monitor 12 compares the programmed tables and may alert. Overcharging and undercharging are identified in the same way.

In another exemplary embodiment, battery monitor 12 keeps two sets of identical logs A 38a and B 38b (shown in FIGS. 6A-6D). Battery monitor 12 may be configured to verify the accuracy of log A 38a and log B 38b, by for example comparing both logs A 38a with each other, or comparing both stored logs B 38b with each other. This may ensure that a sudden loss of power does not corrupt the log data. Log A 38a and log B 38b may include the system time, voltages, temperatures, verification and calibration data, normal state changes, abnormal events, and whether or not an alert was issued.

FIGS. 6A, 6B, 6C and 6D show an exemplary log 38 stored in battery monitor 12. FIG. 6A shows an exemplary page 1 of log 38, FIG. 6B shows an exemplary page 2 of log 38, FIG. 6C shows an exemplary page 3 of log 38, and FIG. 6D shows an exemplary page 4 of log 38. Calibration indicator 39a in log 38 indicates whether battery monitor 12 was calibrated when it first powered up after assembly. Calibration indicators 39b and 39c indicate voltage and temperature during calibration. Calibration may configure battery monitor 12 to function accurately. In an exemplary embodiment, when battery monitor 12 is connected to a 12V power source, battery monitor 12 may start the calibration process automatically. During calibration, battery monitor 12 may measure the voltage and the temperature of the 12 volt power source. Battery monitor 12 may assume that the temperature is 70 degrees Fahrenheit and may run a number of calibrations. For instance, battery monitor 12 may run sixty four calibrations. A complete calibration may include having battery monitor 12 measure the voltage and the temperature of the 12V power source sixty four times.

Battery monitor 12 may store the calibration measurements in log 38. Battery monitor 12 may determine which of the measurements fall within predetermined limits. Battery monitor 12 determines the highest voltage, the highest temperature, the lowest voltage and the lowest temperature measured during the calibration. Battery monitor 12 may be configured to discard the highest and the lowest values.

For example, battery monitor 12 may store all of the measurements, or may store in log 38 all of the measurements but the highest and the lowest measurements. If battery monitor 12 determines that all of the measurements falls within the predetermined limit, battery monitor 12 resolves that the calibration is accurate. If the measurements do not fall within predetermined limits, then battery monitor 12 repeats the calibration process, e.g., battery monitor 12 runs another sixty four calibration attempts. Battery monitor 12 may repeat the calibration process of measuring the voltage and the temperature sixty four times until the measurements fall within the predetermined limits.

In an exemplary embodiment, log 38 includes two sets of logs, log A 38a and log B 38b. Battery monitor 12 may store two sets of log A 38a and two sets of log B 38b in order to prevent data in log A 38a and log B 38b from becoming corrupted. For example, if battery monitor 12 is writing data to log A 38a and suddenly battery monitor 12 looses power while writing to log A 38a, then the data in the other copy of log A 38a will not be corrupted. In this way, battery monitor 12 uses redundancy (a backup copy of log A 38a and log B 38b) to ensure that the data in log 38 is free of errors. The data is stored twice in log 38 using two sets of different logs inside log 38, e.g., two sets of log A 38a and two sets of log B 38b. Battery monitor 12 may store data in log A 38a, which may be an abnormal events log, when there is a change in the state of battery 14 that indicates that battery 14 is in a critical state. Log B 38b may be a normal event log, i.e., a general activity log that tracks all activity, including both normal and abnormal events when there is a change of state or when there is no change of state for a predetermined time such as eighteen hours.

Log 38 may include a system time 40, number of boots 42, number of red alerts 44 and number of yellow alerts 46. System time 40 may indicate the total elapsed time that battery monitor 12 has been running. Number of boots 42 may indicate the number of times battery monitor 12 has powered up. The number of red alerts 44 may indicate the number of red alerts battery monitor 12 has issued. Red alerts 44 may be issued by battery monitor 12 when battery 14 is overcharging (solid red LED lights up), when battery 14 is in a cranking under state (flashing red LED), and when the condition of battery 14 is critical. A red alert may indicate that battery 14 is unhealthy and is in a hazardous condition. A red alert may further indicate to an operator of vehicle 24 that battery 14 should be replaced. An LED flashing red, e.g., a flashing red alert, may indicate impending battery failure. An LED showing a solid red light, e.g., a solid red alert, may indicate overcharging of battery 14.

The number of yellow alerts 46 indicates the number of yellow alerts that battery monitor 12 has issued. Battery monitor 12 may issue a yellow alert when battery 14 is in an idle under state (flashing yellow LED) indicating that the operating condition of battery 14 is less than optimal. A yellow alert may be a warning alert indicating that, while the condition of battery 14 is not critical yet, the condition of battery 14 is not optimal.

Log 38 may also include the number of times a green alert (flashing green light or a steady green light) was issued. A green alert may indicate that battery 14 is in good condition, and that the voltage and temperature of battery 14 are within normal parameters. A green LED that is blinking, e.g., a flashing green alert, may indicate that the battery 14 is fully charged and in idle state. A green LED that is not flashing, but instead shows a solid green light, i.e., a solid green alert, may indicate that the battery 14 is charging normally. As such, battery monitor 12 may be configured to alert by using a flashing green light, a flashing yellow light, a flashing red light, a solid green light, a solid yellow light and/or a solid red light.

Log 38 may store a log A index 48a which indicates where in log A 38a the new data is currently being written. Similarly, log 38 may store a log B index 48b that indicates where in log B 38b the new data is currently being written. Once the maximum amount of space in log A 38a has been used, then battery monitor 12 may start overwriting the data in log A 38a. Likewise, once battery monitor 12 has reached the last location where data could be written to in log B 38b, then battery monitor 12 may start overwriting log B 38b. Each log included in log 38, e.g., log A 38a and log B 38b, may have sixty four lines in which to store data. For instance, each of log A 38a and log B 38b may include lines zero (“0”) through sixty three (“63”). Once line sixty three is full, then battery monitor 12 starts rewriting the respective log, starting with line zero. Each line may include the voltage and temperature measurements obtained at a particular time. Sometimes, each line may correspond to a different time, such that not two lines or locations in log A 38a include the same time. Other times, log B 38b may include two lines that may correspond to a same time but may have different states. This may happen when the voltage of battery 14 is fluctuating between two states. If so, battery monitor 12 records that the voltage is fluctuating between the two states and the time when the fluctuations occurred.

Battery monitor 12 may store in log 38 the number of times battery 14 reached various voltage thresholds and data on whether or not an alert was issued when a voltage threshold was measured. For example, log 38 may include over voltage threshold indicator 50, which may indicate the number of times the voltage in battery 14 reached the over voltage threshold. Log 38 may also store a charging voltage threshold indicator 52. Charging voltage threshold indicator 52 indicates the number of times the voltage in battery 14 reached the charging voltage threshold.

Log 38 may also store a floating voltage threshold indicator 54, idle voltage threshold indicator 56, cranking voltage threshold indicator 58 and under voltage threshold indicator 60. Floating voltage threshold indicator 54 indicates the number of times the voltage in battery 14 reached the floating voltage threshold. Idle voltage threshold indicator 56 indicates the number of times the voltage in battery 14 reached the idle voltage threshold. Cranking voltage threshold indicator 58 indicates the number of times the voltage in battery 14 reached the cranking voltage threshold. Under voltage threshold indicator 60 may indicate the number of times the voltage in battery 14 reached the under voltage threshold. Of note, the voltage of battery 14 may be the normalized voltage at 60 degrees Fahrenheit.

The number of times a voltage threshold was reached by the voltage of battery 14, stored in over voltage threshold indicator 50, charging voltage threshold indicator 52, floating voltage threshold indicator 54, idle voltage threshold indicator 56, cranking voltage threshold indicator 58 and under voltage threshold indicator 60, may be logged regardless as to whether or not an alert was issued when the voltage threshold was reached by battery 14. Alternatively, the number of times a voltage threshold was reached may be recorded only when an alert was issued.

Exemplary log 38 shows that there are two values for system time 40, number of boots 42, number of red alerts 44, number of yellow alerts 46, log A index 48a, log B index 48b, over voltage threshold indicator 50, charging voltage threshold indicator 52, floating voltage threshold indicator 54, idle voltage threshold indicator 56, cranking voltage threshold indicator 58 and under voltage threshold indicator 60. The first value may be the value obtained from data in log A 38a, and the second value may be obtained from data in log B 38b.

Log A 38a may store system time 62, the actual voltage measured 64 (which may not be the voltage after being adjusted for temperature), the actual temperature 66, the state 68 of battery 14 and whether or not an alarm 70 (alert) was issued and which alert was issued. Log A 38a shows low voltages, such as cranking under (“CrU”), idle under (“IdU”) or idle low (“IdL”) as well as empty log space (no entry) still unused. Log B 38b shows mostly normal voltages with almost no alerts issued.

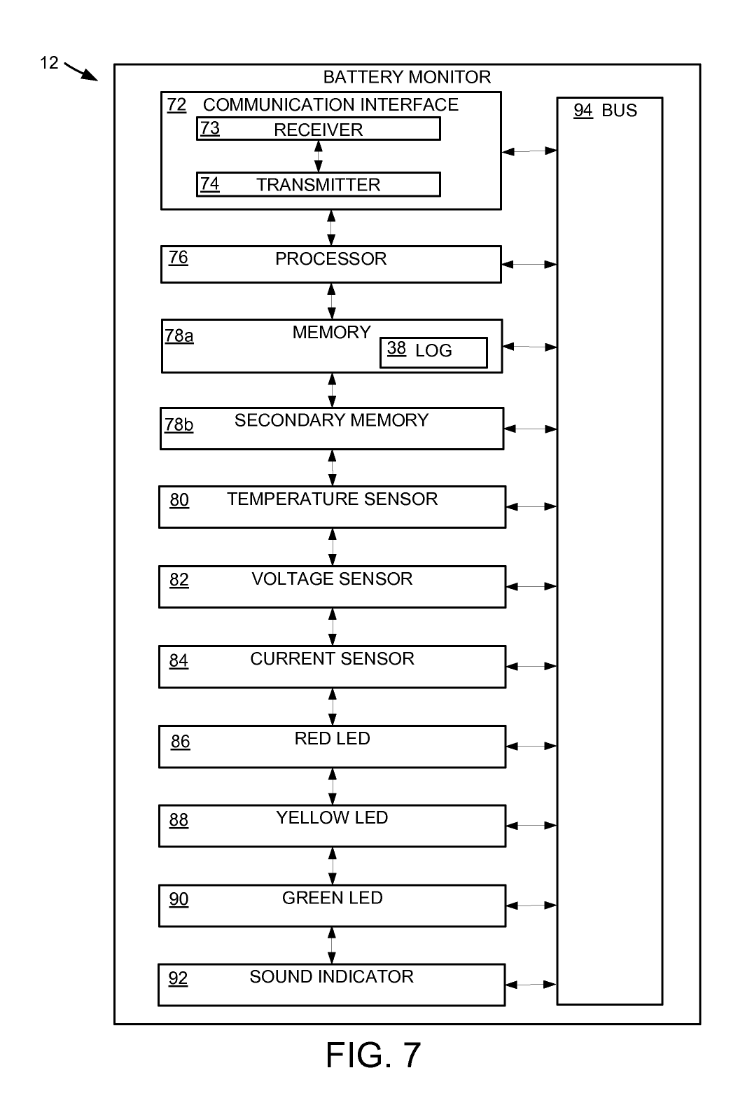

FIG. 7 is a block diagram of an exemplary battery monitor 12. Battery monitor 12 may include communication interface 72 (which may include receiver 73 and transmitter 74), processor 76, memory 78a, secondary memory 78b, temperature sensor 80, voltage sensor 82, current sensor 84, red LED 86, yellow LED 88, green LED 90 and sound indicator 92 in communication with each other directly or via communication bus 94. Battery monitor 12 may include one or more processors, such as processor 76, programmed to perform the functions described herein. Processor 76 may execute computer programs stored on disk storage for execution via secondary memory 78b. Bus 94 may be a communication bus, e.g., a cross bar interconnect, network, etc.

Temperature sensor 80 may be configured to measure the temperature of the cells in battery 14, the ambient temperature, and/or the temperature of electrical system 26. Voltage sensor 82 may be configured to measure the voltage of battery 14 and/or the voltage of electrical system 26. Current sensor 82 may be configured to measure the current through battery 14 and/or the current through electrical system 26.

Battery monitor 12 may optionally include or share a display interface that forwards graphics, text, and other data from the communication infrastructure 94 (or from a frame buffer not shown) for display on a display unit (not shown). The display unit may be a liquid crystal display (LCD), light-emitting diode (LED) display or touch screen display, among other types of displays. Main memory 78a may include random access memory (“RAM”) and read only memory (“ROM”). Main memory 78a may store log 38. Secondary memory 78b may include, for example, a hard disk drive and/or a removable storage drive, representing a removable hard disk drive, magnetic tape drive, an optical disk drive, a flash hard drive, etc. The removable storage drive may read from and/or write to a removable storage media in a manner well known to those having ordinary skill in the art. Removable storage media, represents, for example, a floppy disk, external hard disk, magnetic tape, optical disk, etc. which is read by and written to by the removable storage drive. As will be appreciated, the removable storage media may include a computer usable storage medium having stored therein computer software and/or data.

In alternative embodiments, secondary memory 78b may include other similar devices for allowing computer programs or other instructions to be loaded into battery monitor 12 and for storing data. Such devices may include, for example, a removable storage unit and an interface. Examples of such may include a program cartridge and cartridge interface (such as that found in video game devices), flash memory, a removable memory chip (such as an EPROM, EEPROM or PROM) and associated socket, and other removable storage units and interfaces which allow software and data to be transferred from the removable storage unit to other devices.

Communication interface 72 may allow software and data to be transferred to external devices. Examples of communications interface 72 may include receiver 73, transmitter 74, a modem, a network interface (such as an Ethernet card), a communications port, a PCMCIA slot and card, wireless transceiver, and/or wireless antenna, etc. Software and data transferred via communications interface/module 72 may be, for example, electronic, electromagnetic, optical, or other signals capable of being received by communications interface 72. These signals are provided to communications interface 72 via a communications link (i.e., a channel). The channel carries signals and may be implemented using wire or cable, fiber optics, a phone line, a cellular phone link, an RF link, and/or other communications channels.

It is understood that battery monitor 12 may have more than one set of communication interfaces 72. For example, battery monitor 12 may have a communication interface 72 to establish a communication zone for wireless communication, a second communication interface 72 for low speed, e.g., WLAN, wireless communication, another communication interface 72 for communication with optical networks, another communication interface 72 for Ethernet or wired communications, and still another communication interface 72 for other communication.

Computer programs (also called computer control logic) may be stored in main memory 78a and/or secondary memory 78b. For example, computer programs may be stored on disk storage, i.e. secondary memory 78b, for execution by processor 76 via RAM, i.e. main memory 78a. Computer programs may also be received via communications interface 72. Such computer programs, when executed, enable the method and system to perform the features of the present invention as discussed herein. In particular, the computer programs, when executed, enable processor 76 to perform the features of the corresponding method and system. Accordingly, such computer programs represent controllers of battery monitor 12.

Various software embodiments are described in terms of this exemplary battery monitor 12. It is understood that computer systems and/or computer architectures other than those specifically described herein can be used to implement the invention. It is also understood that the capacities and quantities of the components of the architecture described above may vary depending on the device, the quantity of devices to be supported, as well as the intended interaction with the device. For example, configuration and management of battery monitor 12 may be designed to occur remotely by web browser. In such case, the inclusion of a display interface and display unit may not be required.

Memory 78a may be a non-volatile flash memory that stores data used by battery monitor 12 to determine the condition of battery 14. Memory 78a may store historical data, an abnormal event log and a normal event log in log 38. Memory 78a may also store a set of tables associating battery parameters to temperatures. For example, the set of tables may include Table 1, which may list parameters such as temperature, voltage, normalized voltage, and critical battery parameters versus temperatures ranging from minus 40 degrees Fahrenheit to 150 degrees Fahrenheit. Battery monitor 12 may use the historical data, abnormal event log, normal event log and set of tables in memory 78a during its ongoing analysis of the condition of battery 14.

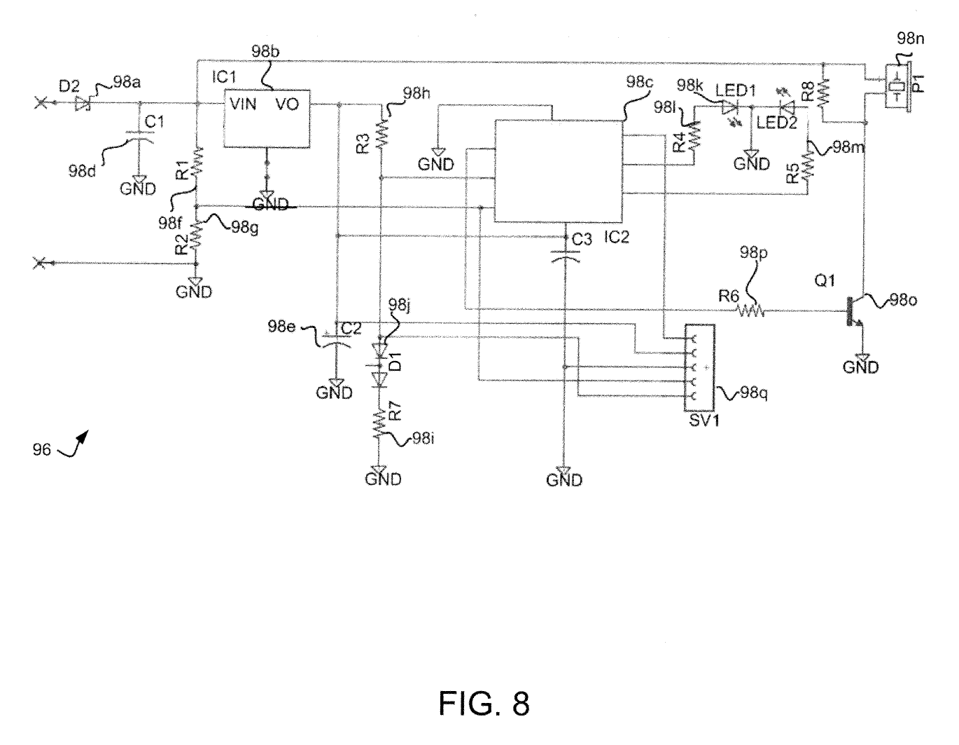

FIG. 8 is a block diagram of an exemplary circuit 96 designed to implement the functions of battery monitor 12. Power to circuit 96 may enter at the left from a 12V vehicle battery. Diode D2 98a may protect against reverse polarity in case the connections to battery 14 are accidentally reversed, i.e., in case first connector 16 (power) and second connector 18 (ground) of battery monitor 12 are accidentally connected backwards. Integrated Circuit IC1 98b may provide a 5V power supply for microcontroller 98c (integrated circuit IC2). Capacitors C1 98d and C2 98e may filter the input and output signal of the power supply to smooth the signals and remove any signal noise. Resistors R1 98f and R2 98g may scale the incoming battery voltage down to the 0 to 5V range required by microcontroller 98c. Microcontroller 98c may be a peripheral interface controller (“PIC”). Microcontroller 98c may be an eight-bit PIC, such as a PIC12F617 (U2), which may include 2,048 14-bit words (3.5K Bytes) of flash memory, 128 bytes of RAM, and a multichannel 10-bit A/D converter. Microcontroller 98c may draw negligible current. Microcontroller 98c may be programmed with embedded software configured to perform the process described herein. The software may be written in any programming language, such as assembly language.

Resistors R3 98h, R7 98i and diode D1 98j form a temperature sensor. The voltage drop across diode D1 98j varies with temperature and is measured by microcontroller 98c. LED1 98k may be a red/green LED. Switching on both a red and green LED may make LED1 98k appear to glow yellow. Resistors R4 981 and R5 98m may limit current to LED1 98k to prevent LED1 98k from getting damaged. Alarm P1 98n may be a piezo audible alarm, and may be driven by NPN bipolar transistor Q1 98o for greater volume. Resistor R6 98p may limit the current flowing through the base terminal of transistor Q1 98o. SV1 98q may be a programming connector used to program microcontroller 98c.

Form Factors

In another exemplary embodiment, battery monitor 12 may come in three different form factors. For example, battery monitor 12 may be an all in one unit configured to be connected to the positive and negative connections of electrical system 26, near battery 14. Battery monitor 12 may also be contained within the case of the vehicle battery itself with electrical connections running to the positive and negative terminals within the wall of the battery case. Alternatively, battery monitor 12 may comprise two different units instead of a single unit. The first unit may be located near battery 14, and may include processor 76, i.e., and the analytic capability of battery monitor 12. The second unit may be located inside a cabin of vehicle 24, such as the passenger/operator compartment of vehicle 24. The second unit may communicate the audio and/or visual alerts, and as such, it may include red LED 86, yellow LED 88, green LED 90 and sound indicator 92. The first unit and the second unit may be in communication via a wired or a wireless interface. Alternatively, the first unit and the second unit may be in communication via data network 36 of vehicle 24. Most vehicles 24 have a complete internal computer network, such as data network 36, which operates all of the major vehicle functions and parts. For example, data network 36 may transmit signals to the air bags in vehicle 24, to starter motor 20, and to a suspension system.

In another exemplary embodiment, battery monitor 12 may come in a fully integrated form, where battery monitor 12 is configured to receive data from data network 36. Battery monitor 12 may receive from data network 36 inputs such as time, date, battery temperature, battery voltage and engine rpm. Battery monitor 12 may use those inputs to determine the health of battery 14 and to determine whether or not to generate an alert. Battery monitor 12 may use data network 36 to transmit a visual alert or an audible alert to an operator or maintenance personnel of vehicle 24. Data from log 38 may be uploaded to the Internet using data network 36, e.g., a communication system of vehicle 24, such as OnStar®.

Set of Tables, Historical Data, Normal Event Log and Abnormal Event Log

In another exemplary embodiment, log 38 may store historical data. Battery monitor 12 may collect historical data, such as cumulative statistics, from a vehicle connected to battery 14. Battery monitor 12 may be connected to vehicle 24 to monitor starter motor 20 of vehicle 24. Historical data may include data associated with starter motor 20, which is collected by battery monitor 12, such as a number of engine cranks (as shown in FIG. 6A, cranking voltage threshold indicator 58 showing that there has been forty three engine cranks), a number of times battery 14 was disconnected and rebooted (shown in FIG. 6A, number of boots 42, showing battery 14 has been disconnected four times), a number and type of alerts issued, all engine voltage measurements, a number of times battery monitor 12 has booted, i.e., number of time battery monitor 12 has been restarted, etc. Other data stored in log 38 may include a total elapsed time battery monitor 12 has been operational, as shown in system time 40.

In another exemplary embodiment, memory 78a may store an abnormal event log. The abnormal event log may store abnormal “out of spec” measurements and/or events with time and temperature. Log A 38a is an exemplary abnormal events log as it shows out-of-spec measurements. For example, battery monitor 12 may measure a voltage of battery 14. Battery monitor 12 may determine that the measured voltage indicates that battery 14 is not in good working condition and may classify the measured voltage as an irregular voltage measurement. Battery monitor 12 may determine that a voltage measurement is irregular by comparing the measured voltage to an acceptable voltage value(s) for a given temperature. Lines zero through sixty three in log A 38a show irregular battery voltages measured by battery monitor 12 for the given temperatures.

The acceptable voltage values may be stored in an Acceptable Voltages Table, such as Table 3, stored in memory 78a. Battery monitor 12 may determine an acceptable voltage to compare the measured voltage to by, for example, selecting an acceptable voltage or acceptable voltage range from the Acceptable Voltages Table based at least in part on a measured temperature. Battery monitor 12 may compare the measured voltage with the acceptable voltage and may determine that the measured voltage is not an acceptable voltage. If so, battery monitor 12 may store the measured voltage in the abnormal event log A 38a. The abnormal event log A 38a may store the last 64 abnormal events with time stamps and ambient temperature.

In another exemplary embodiment, battery monitor 12 may store a normal event log. The normal event log, such as log B 38b, may store normal “in spec” measurements and events with time and temperature. The normal event log may store the last normal events with time stamps and ambient temperature.

Visual and Audible Alerts

In another exemplary embodiment, battery monitor 12 may be configured to give visual and/or audible alerts before the health of battery 14 becomes critical. For example, battery monitor 12 may include indicators configured to alert when the health of battery 14 is not optimal. An indicator may be a visual indicator, such as red LED 86, yellow LED 88 and green LED 90, and/or an audible indicator, such as sound indicator 92. The alert may warn and inform a user of battery 14 that the health of battery 14 is at a critical point. The alert may help prevent a situation where the user is caught off guard by a dead battery.

Green LED 90 may glow green, yellow LED 88 may glow yellow and red LED 86 may glow red to indicate the health status of battery 14. Instead of including yellow LED 88, battery monitor 12 may include green LED 90 and red LED 86, and may light both of them at the same time to create a yellowish light for a yellow alert. If battery monitor 12 determines that battery 14 is in good condition and well charged, green LED 90 may blink green. If battery monitor 12 determines that the condition, e.g., strength, of battery 14 is marginal, yellow LED 88 may blink yellow. If battery monitor 12 determines that the condition of battery 14 is critical, then red LED 86 may blink red.

In another exemplary embodiment, sound indicator 92 may include an audible indicator that plays an alert for a few seconds when the condition of battery 14 is less than optimal or critical. After playing the alert for a few seconds, sound indicator 92 may play the alert occasionally, such as once every hour or once every day. For example, sound indicator 92 may occasionally “chirp” to remind a user that battery 14 is not working properly and needs to be replaced.

Transmission of Data to a Computer

In another exemplary embodiment, battery monitor 12 may be configured to transmit historical data and the event logs, such as the normal event log and the abnormal events log in log 38, to computer 22. Battery monitor 12 may transmit the historical data and the event logs to computer 12 during the first few seconds of battery monitor 12 powering-up. Green LED 90 may blink rapidly to indicate that battery monitor 12 is transmitting information to computer 22.

Monitoring of Other Vehicle Components and Systems

In another exemplary embodiment, battery monitor 12 may monitor other components and systems. For example, battery monitor 12 may monitor a charging system, such as charging electrical system 26 of vehicle 24. Charging system 26 may include, among other components, alternator 30, voltage regulator 28, a fan belt, etc. For instance, battery monitor 12 may determine whether alternator 30 is working properly or whether it is not working properly, whether a fan belt is loose, whether charging system 26 has a faulty electrical connection, whether voltage regulator 28 is defective or working properly, plus many other common problems associated with a charging system. Any failure of one component of the charging system will result in abnormal charging which will be detected by battery monitor 12. Battery monitor 12 may alert the vehicle owner of the abnormal condition with a message such as “Please inspect charging system.” The charging system can then be evaluated by the vehicle owner or technician to find the specific failed component.

Battery

Battery 14 may be a 12V lead-acid battery. Lead-acid battery 14 may be a starting/lighting/ignition (“SLI”) type of battery, such as the type of batteries used in car, trucks and motorcycles. Battery 14 may include six individual cells connected in series. Each cell may produce about 2.108 volts at room temperature. As such, battery 14 may be a 12V lead-acid battery which produces 12.65V at room temperature when battery 14 is fully charged (6×2.108V=12.65V). The cell voltage of the cells of battery 14 drops rapidly with temperature. As the temperature drops, the output voltage of the battery also drops. For example, at zero degrees Fahrenheit, the fully charged voltage may be only 2.086V per cell and the output voltage may be reduced to approximately 2.52V (6×2.086V=12.52V). The temperature of the cells of battery 14 may be measured with temperature sensor 80.

State of Charge

In an exemplary embodiment, battery monitor 12 may measure a state of charge (“SOC”) of battery 14. The SOC is a common measurement of the condition of battery 14. The SOC may be expressed as a percentage. For instance, battery monitor 12 may determine whether battery 14 is fully charged, i.e., the SOC is 100%, fully discharged, i.e., the SOC is 0%, or somewhere in between fully charged and fully discharged. Battery monitor 12 may continuously estimate the SOC of battery 14 by measuring a no-load output voltage of the battery, the ambient temperature, and then using a set of lookup tables available in the public domain.

Battery monitor 12 may be configured to issue an alert if the estimated SOC drops below a minimum threshold such 30%. Battery monitor 12 may determine that the SOC of battery 14 is low if the SOC lies at or below 30%. Battery monitor 12 may determine that the estimated low SOC may not necessarily mean that battery 14 is not working properly, but rather has discharged from lack of use or current drain. For example, battery monitor 12 may determine that the SOC of battery 14 is low, i.e., battery 14 is low on charge because the headlights were left on or because charging system 26 is not working.

Cranking Math

Battery monitor 12 may measure the current output of battery 14 when battery 14 is electrically connected to starter motor 20. Starter starter motor 20 may have a direct current resistance of 0.08 ohms. Starter starter motor 20 may draw approximately 158 amps of peak current (12.65V divided by 0.08 ohms) when connected to an ideal battery. The average current drawn depends on many factors including the duty cycle, the mechanical load on the motor, etc. Battery monitor 12 may measure the current and may determine that the instantaneous current fluctuates rapidly depending on the mechanical load on starter motor 20 at any time—whether a winding is energized (and which one), whether a magnetic field is just starting to form, already established or collapsing, and many other factors. The peak current and the average current through starter motor 20 may be quite different from each other.

Battery monitor 12 may measure the current output of battery 14, which may have a 0.02 ohms resistance and may be connected to starter motor 20, which may have a 0.08 ohms resistance. The total load may be 0.01 ohms (0.02 ohms+0.08 ohms). Battery monitor 12 may measure as the peak current 127 amps (12.65 V divided by 0.01 ohms). Battery monitor 12 may measure a minimum voltage across starter motor 20 (and also the battery posts, assuming the connecting cables have no resistance) of 10.16 V (127 amps multiplied by 0.08 ohms). As such, a fully charged battery 14 may be capable of delivering 633 amps. However, when starter motor 20 is engaged, the voltage across the battery terminals may drop to around 10.16 V.

As lead-acid battery 14 ages, the internal resistance of battery 14 gradually increases due to sulfation, (the chemical build-up of hard lead sulfate crystals on the internal metal plates in battery 14). The rate of sulfation increases as the SOC of battery 14 drops. The rate of sulfation also increases with temperature. If battery 14 is poorly charged and hot, battery 14 will experience a higher rate of sulfation than if it was fully charged and cold. Given that the effects of sulfation are cumulative and largely irreversible, the internal resistance of battery 14 keeps increasing. The ever-increasing internal resistance gradually reduces the peak output of battery 14 until battery 14 can no longer perform, e.g., battery 14 can no longer start vehicle 24. Sulfation is a common reason why lead-acid batteries fail.

State of Health (“SOH”)

In another exemplary embodiment, if battery 14 is affected by sulfation, the internal resistance of battery 14 may increase from 0.02 ohms to 0.04 ohms. When starter starter motor 20 is engaged, battery monitor 12 may measure an effective load of 0.12 ohms (0.04 ohms plus 0.08 ohms). Battery monitor 12 may measure the peak current flow as 105 amps (12.65V divided by 0.12 ohms). The voltage across started starter motor 20 (and battery posts, assuming the cables have no resistance) may drop as low as 8.4V (105 amps times 0.08 ohms). If the SOC and SOH of battery 14 is considered good, the voltage may remain above 9V when the vehicle is started at a temperature of approximately 70 degrees Fahrenheit. If the voltage does not remain above approximately 9V, battery 14 may require maintenance, e.g., one or more cells which may be low on electrolytes and may need water, or battery 14 may need to be replaced. If battery monitor 12 determines that the SOC of battery 14 is adequate and battery 14 has not experienced significant sulfation, then the voltage may not drop below roughly 9V when the vehicle is started, e.g., when starter motor 20 is started, unless battery 14 is nearing end of life. In this case, battery 14 should be replaced. Battery monitor 12 monitors battery 14 and determines whether the voltage drops below 9V. Battery monitor 12 may issue an alert when a voltage below 9V is detected.

Charging System

In another exemplary embodiment, once starter motor 20 starts, alternator 30 of vehicle 24 replenishes the energy of starter motor 20, which was used by cranking. Alternator 30 may produce a varying alternating current (“AC”) voltage linked to the revolutions per minute (“RPM”) of starter motor 20. The voltage is rectified to create an unregulated DC voltage. The unregulated DC voltage is fed to linear voltage regulator 28 which provides approximately 14.4 DC to power the electrical and charging systems of vehicle 24. The regulated charging voltage can vary from about 13.5V to 14.8V, depending at least on the make and model of vehicle 24, whether the headlights or other accessories are on, the SOC and the temperature, among other variables. Some vehicles may have a fixed output voltage regulator, while others may have regulators that are manually adjustable. A higher charging voltage is desirable when battery 14 is cold, and a lower charging voltage is desirable when battery 14 is hot. A variable voltage regulator may include a built-in temperature compensator, which allows a higher charging voltage when battery 14 is cold, and a lower charging voltage when battery 14 is hot. Battery monitor 12 may continuously monitor charging system 26 of vehicle 24 and may issue an alert if it detects a problem, such as overcharging by alternator 30.

Software Operation

In another exemplary embodiment, battery monitor 12 may be pre-programmed with embedded software. Battery monitor 12 may measure the battery voltage many times per second. For instance, battery monitor 12 may sample the battery voltage of battery 14 about 200 times per second. Also, battery monitor 12 may monitor the ambient temperature at predetermined intervals, such as twice per second. Battery monitor 12 normalizes each voltage measurement to compensate for ambient temperature, and may take a different action depending on the current operating state of starter motor 20, e.g., the vehicle. Battery monitor 12 may discover a problem and issue an audible alert and/or visual alert by choosing which LED to illuminate.

For example, when battery monitor 12 determines that starter motor 20 is in a charging state, e.g., the vehicle is running or a charger is attached, battery monitor 12 monitors charging system 26 of vehicle 24. Additionally, battery monitor 12 monitors the charging voltage of battery 14 and the surface charge dissipation of battery 14. If battery monitor 12 determines that starter motor 20 is in an idle state, e.g., the vehicle is not in use, battery monitor 12 computes and monitors the SOC of battery 14. Battery monitor 12 may continuously estimate the SOC of battery 14 by measuring a no-load output voltage of the battery, the ambient temperature, and then using a set of lookup tables available in the public domain. If battery monitor 12 determines that starter motor 20 is in a cranking state, e.g., starter motor 20 is engaged, battery monitor 12 computes and monitors the SOH of battery 14. Battery monitor 12 may continuously estimate the SOH of battery 14 by measuring a no-load output voltage of battery 14, the ambient temperature, and then using a set of lookup tables available in the public domain. Aggregate statistics, normal state changes and any alerts may be logged and stored in the flash memory of microcontroller 98c, together with timestamps and the ambient temperature.

Battery monitor 12 may perform other functions, such as diagnostics, calibration, optical data transmission, maintenance of historical and log data stored in flash memory of microcontroller 98c, and tracking the operating state of vehicle 24.

Calibration

The first time battery monitor 12 is powered up with 10V DC or more, battery monitor 12 may be configured to calibrate itself. If battery monitor 12 is to be tested before calibrating, battery monitor 12 may be powered with a 9V transistor battery, as battery monitor 12 may not attempt to calibrate itself when powered by 9V DC. The accuracy of the calibration reference may help with the proper operation of battery monitor 12.

Mechanical

In another exemplary embodiment, battery monitor 12 may include an adhesive backing or a Velcro® backing. Battery monitor 12 may be mounted right on battery 14 or in any other convenient location, including inside vehicle 24. If battery monitor 12 is not positioned on battery 14, then a fourteen gauge or larger wire may be used to minimize the voltage drop. Battery monitor 12 may also be positioned on a dashboard of vehicle 24, such as a truck, when the noise of starter motor 20 may make it difficult to hear the alert issued by battery monitor 12 when battery monitor 12 is located under the hood of vehicle 24.

In another exemplary embodiment, an optical data reader may be configured to receive, analyze, print and archive the data transmissions from battery monitor 12, such as the historical data and event logs. The optical data reader may capture the data and may send the data to computer 22 for display on a display of computer 22.

The present invention can be realized in hardware, or a combination of hardware and software. Any kind of computing system, or other apparatus adapted for carrying out the methods described herein, is suited to perform the functions described herein. A typical combination of hardware and software could be a specialized computer system, e.g., a point of sale terminal, having one or more processing elements and a computer program stored on a storage medium that, when loaded and executed, controls the computer system such that it carries out the methods described herein. The present invention can also be embedded in a computer program product, which comprises all the features enabling the implementation of the methods described herein, and which, when loaded in a computing system is able to carry out these methods. Storage medium refers to any volatile or non-volatile storage device.

Computer program or application in the present context means any expression, in any language or notation, of a set of instructions intended to cause a system having an information processing capability to perform a particular function either directly or after either or both of the following a) conversion to another language, code or notation; b) reproduction in a different material form.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A battery monitor, comprising:
a memory;
a processor, the processor in communication with the memory, the processor configured to:
determine a state of a battery;
determine whether to generate an alert based at least in part on the state; and
if the processor determines to generate the alert, the memory is configured to store a type of the alert and the state of the battery.

2. The battery monitor of claim 1, wherein determining the state of the battery further comprises determining a voltage and a temperature of the battery; and wherein the memory is further configured to store the voltage, the temperature and a time when the processor determined the state of the battery, and wherein the alert generated is one of an audio and a visual alert.

3. The battery monitor of claim 1, wherein the state of the battery is one of a plurality of states, and wherein the memory is further configured to store a number of times the processor determined that the battery was in each of the plurality of states.

4. The battery monitor of claim 1, further including a communication interface in communication with the memory and the processor, the communication interface comprising a transmitter configured to send wirelessly one of a text message and an email message including the state of the battery to a computer.

5. The battery monitor of claim 1, wherein the type of the alert is one of a plurality of alert types, and wherein the memory is further configured to store a number of times each of the plurality of alert types was generated.

6. The battery monitor of claim 1, wherein the memory is further configured to store a normal events log and an abnormal events log, and wherein:
when the processor determines that the state of the battery changed, the memory is configured to store the state, a voltage of the battery and a temperature of the battery in the normal events log; and
when the processor determines that the state of the battery is not normal, the memory is configured to store the state, the voltage of the battery and the temperature of the battery in the abnormal events log.

7. The battery monitor of claim 1, further comprising a communication interface in communication with the memory and the processor, the communication interface including a receiver configured to receive, from a data network of a vehicle connected to the battery, a voltage and a temperature of the battery.

8. The battery monitor of claim 7, wherein the receiver is further configured to receive, from the data network of the vehicle, a number of revolutions per minute of an engine of the vehicle and an intake manifold temperature.

9. The battery monitor of claim 8, wherein the receiver is further configured to receive from the data network a cabin temperature of a cabin of the vehicle.

10. The battery monitor of claim 9, wherein the receiver is further configured to receive from the data network a calendar date and a time.

11. The battery monitor of claim 7, wherein the communication interface further includes a transmitter, the transmitter transmitting to the data network the alert generated by the processor, the alert including instructions for the vehicle to present the alert to an operator of the vehicle.

12. A method, comprising:
determining a state of a battery using a battery monitor;
determining, by the battery monitor, whether to generate an alert based at least in part on the state; and
if a determination is made to generate the alert, storing a type of the alert and the state of the battery in a log stored in the battery monitor.

13. The method of claim 12, wherein determining the state of the battery further comprises determining a voltage and a temperature of the battery, the method further comprising:
storing, by the battery monitor, the voltage, the temperature and a time the state of the battery is determined in the log;
generating the alert, the alert being one of an audio and a visual alert.

14. The method of claim 12, wherein the state of the battery is one of a plurality of states, the method further comprising:
storing, in the log of the battery monitor, a number of times the battery was in each of the plurality of states.

15. The method of claim 12, further comprising:
wirelessly sending, by the battery monitor, one of a text message and an email message including the state of the battery to a computer.

16. The method of claim 12, wherein the type of the alert is one of a plurality of alert types, the method further comprising:
storing, in the log of the battery monitor, a number of times each of the plurality of alert types was generated.

17. The method of claim 12, further comprising:
receiving, at the battery monitor, a voltage and a temperature of the battery from a data network of a vehicle connected to the battery.

18. The method of claim 17, further comprising:
receiving, at the battery monitor, a number of revolutions per minute of an engine of the vehicle, an intake manifold temperature, and a cabin temperature of a cabin of the vehicle from the data network.

19. The method of claim 17, further comprising:
transmitting, by the battery monitor to the data network, the generated alert, the alert including instructions for the vehicle to present the alert to an operator of the vehicle.

20. A system, comprising:
a vehicle, the vehicle including a battery and a data network; and
a battery monitor in communication with the vehicle via the data network, the battery monitor connected to the battery, the battery monitor comprising:
a memory;
a processor, the processor in communication with the memory, the processor configured to:
determine a state of the battery;
determine whether to generate an alert based at least in part on the state; and
if the processor determines to generate the alert, the memory is configured to store a type of the alert and the state of the battery; and
a transmitter in communication with the memory and the processor, the transmitter configured to transmit the alert to the vehicle via the data network; and
the vehicle configured to present the alert to an operator of the vehicle.
